(19) United States
(12) Patent Application Publication
(10) Pub. No.: US 2003/0187780 A1
(43) Pub. Date: Oct. 2, 2003

(54) Systems and methods for managing collections relating to merchant accounts

(75) Inventors: Mark G. Arthus, Nesconset, NY (US); Michael L. Sgaraglio, Massapequa Park, NY (US); William S. Miller, Bayshore, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO

(21) Appl. No.: 10/108,785

(22) Filed: Mar. 27, 2002

(51) Int. Cl. G06F 17/60

(52) U.S. Cl. 705/39

(57) ABSTRACT

A method for facilitating the collection of outstanding funds from merchants having an outstanding funds balance includes receiving at a server computer transaction information relating to a plurality of merchants and receiving a request to generate a list of merchants exceeding certain payment risk criteria. The method also includes transmitting the list to a collections computer and receiving a request at the server computer to view account information for one of the merchants on the list. The method further includes transmitting requested account information and receiving “follow up” information at the server computer relating to actions taken by a collections officer to reduce the payment risk. Associated systems are also provided.

### CROSS-REFERENCES TO RELATED APPLICATIONS

This application is related to commonly assigned and concurrently filed U.S. patent application Ser. No. ______, entitled “DECISION TREE SYSTEMS AND METHODS” (Attorney Docket No. 020375-008200US), by Mark G. Arthus, et al., and to commonly assigned and concurrently filed U.S. patent application Ser. No. ______, entitled “SYSTEMS AND METHODS FOR MONITORING CREDIT RISK” (Attorney Docket No. 020375-008500US), by Michael L. Sgaraglio, and to commonly assigned and concurrently filed U.S. patent application Ser. No. ______, entitled “MERCHANT APPLICATION AND UNDERWRITING SYSTEMS AND METHODS” (Attorney Docket No. 020375-007100US), by Michael L. Sgaraglio, et al., and to commonly assigned and concurrently filed U.S. patent application Ser. No. ______, entitled “MERCHANT ACTIVATION TRACKING SYSTEMS AND METHODS” (Attorney Docket No. 020375-023900US), by Michael L. Sgaraglio, et al., and to commonly assigned and concurrently filed U.S. patent application Ser. No. ______, entitled “SYSTEMS AND METHODS TO MONITOR CREDIT FRAUD” (Attorney Docket No. 020375-008400US), by Mark G. Arthus, et al., which applications are incorporated herein by reference in their entirety for all purposes.

### BACKGROUND OF THE INVENTION

This invention relates generally to the field of financial transactions, and in particular to monitoring outstanding debit balances associated with credit services between merchants and credit service providers. More specifically, in one aspect the invention relates to systems for facilitating the collection of outstanding funds from merchants.

Financial transactions involving the use of presentation instruments, such as credit cards, play an important role in today's economy. A typical credit card transaction proceeds by extracting account information from the credit card, typically using a point of sale device at a merchant location, and submitting the account information along with a requested payment amount to a processing system. Such a processing system may involve the merchant's bank, a credit card association, such as VISA or MasterCard, and the issuer's bank as is known in the art.

Hence, in order to process a credit card transaction, a merchant must typically establish an account with a processing organization. Because the processing organization takes on certain financial risks when agreeing to process a merchant's transactions, an application and underwriting process typically takes place before an account is opened. For example, an account may be established by first requiring the merchant to fill out a credit application. The credit application is then sent to an underwriter who reviews information in the application to determine whether the merchant would be a suitable client. If so, the account is established, and the merchant may begin accepting at least certain types of credit cards as payment for their goods or services.

Thereafter, circumstances may arise wherein the merchant accumulates an outstanding balance of funds owed to the processing organization. For example, the merchant may process charge backs to customers who are paid by the processing organization, yet the merchant may not remit funds to reimburse the processing organization. Thus, credit processing organizations desire to monitor such outstanding balances and collect the funds from the merchant.

In some circumstances, a credit issuing or processing organization may determine that it should maintain funds in reserve for certain merchants to offset the possibility that the merchant may accumulate an outstanding balance which goes unpaid. This may be the case, for example, if the underwriting process identifies the merchant or the merchant's business as constituting excessive risk. Thereafter, any outstanding balance accumulated by a merchant may be evaluated in light of the reserve funds maintained for the merchant. Thus, credit processing organizations desire to monitor reserve balances associated with their merchant-clients.

Hence, there is a need in the art for systems and methods that improve the management of collections relating to merchant accounts.

### BRIEF SUMMARY OF THE INVENTION

Embodiments of the present invention thus provide a method of facilitating the collection of outstanding funds from merchants having an outstanding funds balance. The method includes receiving at a server computer transaction information relating to a plurality of merchants and receiving a request to generate a list of merchants exceeding certain payment risk criteria. The method also includes transmitting the list to a collections computer and receiving a request at the server computer to view account information for one of the merchants on the list. The method further includes transmitting requested account information and receiving “follow up” information at the server computer relating to actions taken by a collections officer to reduce the payment risk.

In embodiments of the invention the payment risk criteria includes only merchants having outstanding funds balances over a particular amount. The follow up information may include flagging the merchant for subsequent review at a future date. The payment risk criteria may include only merchants flagged for review after a particular date.

In another example of the present invention, a method for facilitating the collection of outstanding funds from merchants having an outstanding funds balance includes receiving at a server computer transaction information relating to a plurality of merchants and receiving a request to generate a list of merchants exceeding certain payment risk criteria. The method also includes transmitting the list to a collections computer and receiving a request at the server computer to view account information for one of the merchants on the list. The method further includes transmitting requested account information and receiving “account treatment” information at the server computer relating to how an analyst has applied collected funds to an account. The method may include summarizing the account treatment information and transmitting the summarized account treatment information to a general ledger.

In another example of the invention, a method of collecting outstanding funds from a merchant includes requesting from a server computer a list of merchants having outstanding balances and selecting one of the merchants. The method also includes requesting from the server computer a file of information relating to the selected merchant. The method further includes using the merchant information to attempt to collect funds from a merchant account using an electronic funds transfer. The method may include sending a dunning letter to the merchant. The method may also include using the information to contact a principal representing the merchant. The method may also include forwarding the information to an attorney for the commencement of judicial proceedings to attempt to collect funds from the merchant.

In another embodiment of the invention, a method of allocating funds collected from a merchant includes, from a financial analyst computer, requesting from a server computer a list of merchants from whom funds have been collected. The method also includes selecting one of the merchants and requesting from the server computer a file of information relating to the selected merchant. The method also includes entering information into the financial analyst computer to allocate the funds in a particular manner. The funds may be allocated to a reserve account to be held to offset the possibility that the merchant may accumulate a balance of funds owed. At least a portion of the funds may be allocated to cover at least a portion of an outstanding balance accumulated by the merchant.

In another embodiment of the invention, a method of facilitating the allocation of reserve funds includes receiving at a server computer a request from a financial analyst to transmit a list of merchants having reserve funds and transmitting the list to a financial analyst computer. The method also includes receiving at the server computer a request from the financial analyst to transmit merchant information relating to one of the merchants in the list of merchants. The merchant information includes an amount of reserve funds for the requested merchant. The method further includes transmitting the requested merchant information to the financial analyst computer and receiving at the server computer an instruction to allocate the reserve funds in a certain manner. The instruction may include liquidating at least a portion of the reserve funds to cover at least a portion of an outstanding balance accumulated by the first merchant.

In another embodiment of the invention, a method is implemented in a computer system. The a computer system is configured to facilitate debt collection and includes a server computer and a database associated with the server computer. The database includes electronic records identifying merchants having balances of funds owed, and the electronic records include a balance owed field that indicates an amount owed and a write-off field that indicates any portion of the outstanding balance deemed uncollectible and written off for accounting purposes. At least one merchant has a write-off amount in the write-off field of an electronic record associated with the merchant. The method includes including the identify of the merchant in a list of merchants having balances of funds owed and periodically transmitting the list from the server computer to a collection officer computer. the method also includes attempting to collect funds from the merchant. The method may include receiving funds from the merchant and entering an instruction into a data entry screen on the collection officer computer to account for the funds as a collection against a write-off. The method may also include transmitting the instruction to the server computer and storing the amount of funds received in the electronic record associated with the merchant.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 is a schematic diagram illustrating a computer system for facilitating according to an embodiment of the present invention;

FIG. 2 is a flow diagram illustrating an embodiment of a method of facilitating the collection of outstanding funds according to the present invention;

FIG. 3 is a flow diagram illustrating another embodiment of a method of facilitating the collection of outstanding funds according to the present invention;

FIG. 4 is a flow diagram illustrating another embodiment of a method of facilitating the collection of outstanding funds according to the present invention;

FIG. 5 is a query screen display for selecting merchants referred to collections according to embodiments of the present invention;

FIG. 6 is a display screen for listing merchants referred to collections according to embodiments of the present invention;

FIG. 7 is an ‘A’ information screen for listing information relating to a merchant referred to collections according to embodiments of the present invention;

FIGS. 8A and B are top and bottom portions, respectively, of a ‘B’ information screen for listing information relating to a merchant referred to collections according to embodiments of the present invention;

FIG. 9 is a principal/guarantor screen for listing information relating to a merchant referred to collections according to embodiments of the present invention;

FIG. 10 is a comments screen for listing information relating to a merchant referred to collections according to embodiments of the present invention;

FIG. 11 is a transaction screen for listing transactions associated with a merchant referred to collections according to embodiments of the present invention;

FIG. 12 is a transaction entry screen for entering transactions relating to a merchant referred to collections according to embodiments of the present invention; and

FIG. 13 is a reports request screen for generating reports relating to the present invention.

### DETAILED DESCRIPTION OF THE INVENTION

Embodiments of the present invention provide systems and methods for credit issuers to manage collections relating to credit services. This detailed description presents the invention in a non-limiting example relating to credit card processing organizations. Throughout this description, reference is made to certain well known systems, products and processes, such as, for example, the Internet, web sites, web site browsers, databases, and the like, which will not be described in detail in order not to unnecessarily obscure the present invention. In light of this detailed description, those skilled in the art will realize how to make and use the present invention in a number of different embodiments using a range of equivalents to elements discussed herein, all of which are within the scope of the present invention as defined by the claims that follow.

Credit services may be established with essentially any type of person, entity, organization, business, or the like that wishes to take payments for goods or services in the form of a credit, and, for convenience of discussion, are generally referred to herein as “merchants”. Such merchants may process a credit transaction based on an account identifier presented at the time of payment. The account identifier is used to identify the account to which the credit will eventually be posted. In many cases, the account identifier is provided on some type of presentation instrument, such as a credit card, debit card, smart card, stored value card, or the like. Conveniently, the account identifier may be read from a point of sale device, such as those described in copending U.S. application Ser. No. 09/634,901, entitled “POINT OF SALE PAYMENT SYSTEM,” filed Aug. 9, 2000 by Randy J. Templeton et al., which is a nonprovisional of U.S. Prov. Appl. No. 60/147,899, entitled “INTEGRATED POINT OF SALE DEVICE,” filed Aug. 9, 1999 by Randy Templeton et al, the complete disclosures of which are herein incorporated by reference. However, the account identifier may be obtained in other ways, such as by visual inspection of the presentation instrument, by telephone, over the Internet, and the like.

The user account information is transmitted to a credit processing service that approves and processes the transaction information and provides payment to the merchant. As is known, various other organizations may also participate in the transaction in order to bill the user for the transaction, including the issuing bank, the merchant's bank, a credit card association, and the like. The credit processing service may also handle “charge backs”, e.g. when the card holder requests a refund and the account is credited. One example of a credit processing service is the service provided by First Data Corporation, Greenwood Village, Colo.

Prior to establishing services with a merchant, a credit processing organization may conduct an underwriting process using information provided by a merchant-applicant. Systems and methods for establishing and maintaining merchant accounts are more fully explained in previously incorporated U.S. patent application Ser. No. ______, entitled “MERCHANT APPLICATION AND UNDERWRITING SYSTEMS AND METHODS”, and in previously incorporated U.S. patent application Ser. No. ______, entitled “MERCHANT ACTIVATION TRACKING SYSTEMS AND METHODS”. Because credit processing organizations are exposed to the potential that some merchants may accumulate an outstanding balance owed to the credit processing organization, the underwriting process may include a recommendation to maintain finds in reserve to offset the potential.

Once a merchant is accepted as a client and the merchant begins accepting credit cards and other presentation instruments for payment, a credit processing organization may choose to monitor the activities of the merchant with respect to the transactions within which the merchant participates. The transactions may include both sales of goods and services and credits for goods and services returned or refused. The transactions may also include payments by the credit processing organization to the merchant. For convenience, sales and returns will be referred to herein as “charges” and “charge backs”. The types of transactions a merchant participates in, the goods or services purchased in the transactions, and the customers with whom the merchant transacts all warrant observation for a variety of reasons.

First, a merchant may begin using his account in ways that result in a greater degree of credit risk than the merchant represented during the underwriting process. Thus, the credit processing organization may desire to establish a reserve of finds to offset the additional risk presented by the merchant. Systems and methods for monitoring credit risk associate with merchant's accounts are more fully described in previously incorporated U.S. patent application Ser. No. ______, entitled “SYSTEMS AND METHODS FOR MONITORING CREDIT RISK”. Second, a merchant may begin using his account fraudulently. Thus, the credit processing organization may desire to close the merchant's account or establish a reserve of funds to offset the potential that the merchant is using the account fraudulently. Systems and methods for monitoring credit fraud are more fully explained in previously incorporated U.S. patent application Ser. No. ______, entitled “SYSTEMS AND METHODS TO MONITOR CREDIT FRAUD”. Third, a merchant may accumulate a balance of funds owed to the credit processing organization that goes unpaid. Each of these three possibilities may result in a merchant' account being referred to the collections organization.

According to the present invention, financial data, including merchant transaction information, is recorded over time for the merchants doing business with the credit processing organization. For reasons such as those previously mentioned, merchant's accounts are occasionally referred to collections. If the merchant has accumulated a balance of funds owed to the processing organization that the merchant is not paying, a collections officer may attempt to obtain the funds in any of a number of ways. The present invention facilitates the process.

According to the present invention, the collections officer may request a list of merchants referred to collections. The collections officer may request that the list contain only merchants meeting certain criteria. For example, the collections officer may request to view only merchants assigned to him or only merchant in a certain portfolio of accounts. The collections officer may request to view only merchants with outstanding balances above a certain amount. Many other selection criteria are possible. The list is then provided to the collections officer from a server computer.

From the list, the collections officer may select a merchant from whom to attempt to collect funds. The collections officer requests from the server computer more detailed information relating to the merchant, and the information is provided. The information may include the merchant's bank account numbers, other credit account numbers and the like. The information may also include address information for the merchant, the merchant's place of business, and the merchant's principals or guarantors. Using this information, the collections officer may attempt to contact the merchant or the merchant's representatives, or the collections officer may attempt to obtain funds from any of the merchant's other accounts. The collections officer may also send letters to the merchant or refer the outstanding balance to an attorney for judicial proceedings to attempt to recover the funds. Many other actions are possible. According to the present invention, the collections officer documents his attempts to collect funds in an electronic file associated with the merchant that is send to a server computer and stored for later use.

If the collections officer is successful obtaining funds from a merchant or if reserve funds relating to a merchant's account require allocation, the present invention may facilitate the work of a financial analyst. In a manner similar to a collections officer as explained above, a financial analyst may request to view a list of merchants, and select from the list a merchant to view in more detail. According to the invention, the financial analyst may enter accounting transactions to allocate collected funds against appropriate debit transactions. The financial analyst also may determine the appropriate allocation for reserve funds collected from a merchant. The financial analyst also may determine the most appropriate reserve funds to liquidate to cover a merchant having a balance of funds owed. Many other alternatives are possible.

Conveniently, the work of either a collections officer or a financial analyst according to the present invention may be further assisted through the use of decision trees. Using decision trees to assist with the functions of a credit processing organization is more fully explained in previously incorporated U.S. patent application Ser. No. ______, entitled “DECISION TREE SYSTEMS AND METHODS”. Further, embodiments of the present invention include a web browser interface that allows users such as financial analysts and collections officers to access merchant information via a network, such as the Internet. Using a well know web browser environment, users may accomplish their tasks from virtually any location.

According to the present invention, the financial transactions entered by a financial analyst may serve as a sub-ledger and be summarized and reported to a general ledger using a much smaller number of transactions. Thus, collections and reserve information may be presented more clearly in summary form; however, the more detailed information remains available for more in depth review and analysis.

The present invention also provides a detailed reporting capability for all aspects of collections activity. Reports are available for monitoring merchant account activity, as well as, the productivity of the collections officers and financial analysts.

Having described the present invention generally, the invention will be described in more detail using a specific, non-limiting example. Although the examples herein relate to credit processing organizations, the present invention is in no way limited by these examples.

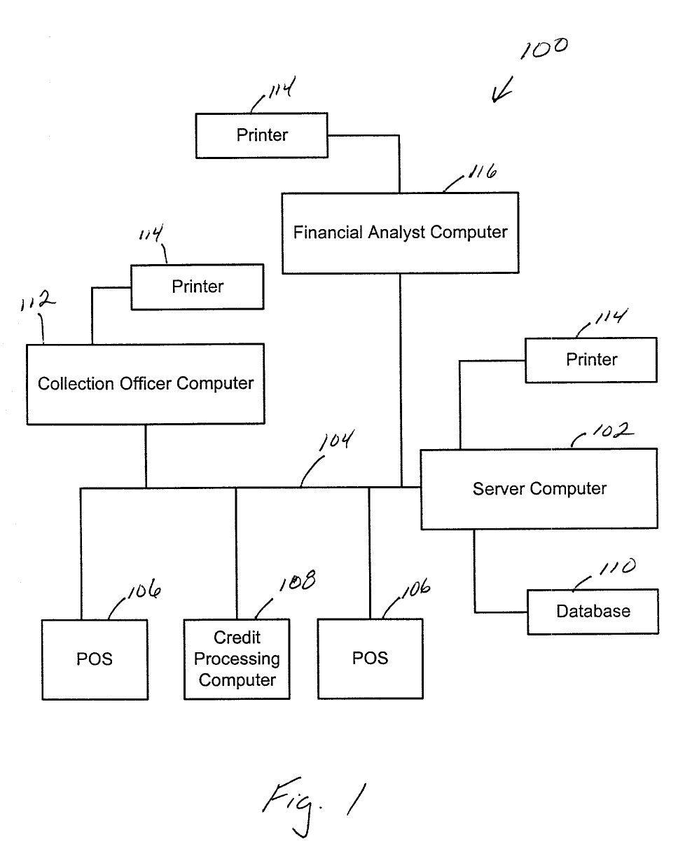

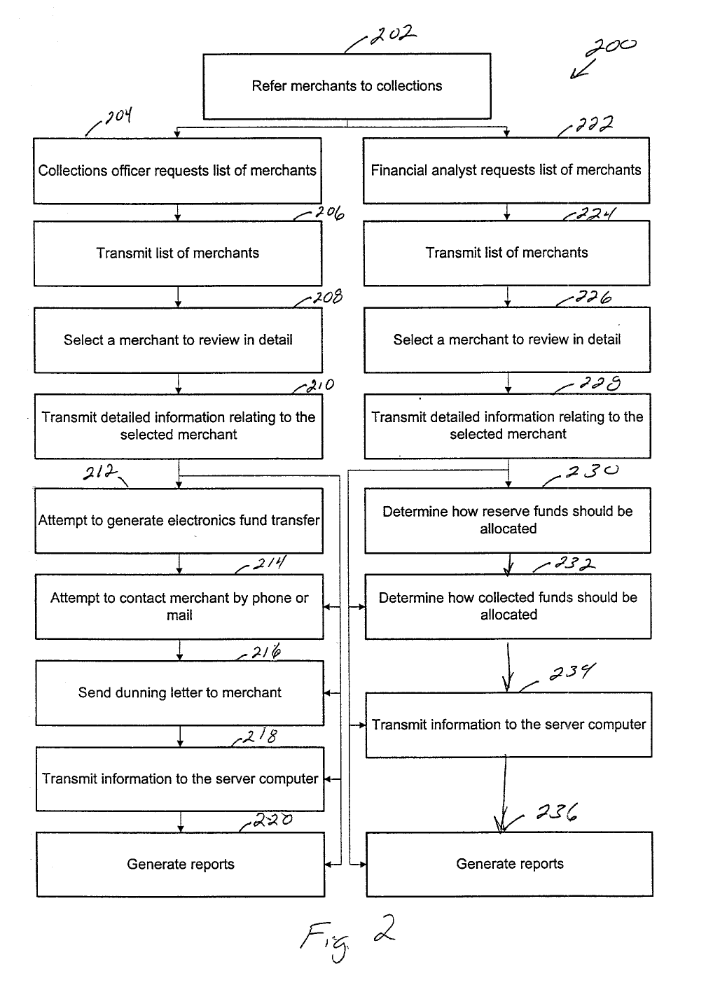

Referring to FIG. 1, a first embodiment of a system 100 for monitoring credit risk is illustrated. The system 100 includes a server computer 102 connected to a network 104. The server computer 102 may be any of a number of computing devices known to those skilled in the art, such as, for example, a personal computer, a workstation, or the like. Application programs residing on the server computer 102 allow the server computer to send and receive files from other computing devices. A suitable interface, as is known in the art, allows the server computer 102 to communicate with other devices via the network 104. The network 104 may be, for example, a wide area network, a local area network, the Internet, or the like.

The server computer 102 is configured to receive merchant credit transaction information from one or more point of sale deices 106 or credit processing computers 108. The server computer 102 causes the transaction information to be stored on a data storage arrangement. The data storage arrangement, or database 110, may be any one or a combination of well known types of recording media, including, for example, magnetic tape, disk drives, optical storage systems and the like. The database 110 may be integral to the server computer 102 or located elsewhere such that the server computer 102 accesses the database 110 via a network.

Through the network 104, the server computer 102 is able to exchange information with one or more collection officer computers 112. For example, the server computer 102 periodically generates a list of merchants whose accounts have been referred to collections. Accounts may be referred to collections for many reasons, some of which were described previously. For example, an account may be referred to collections because the merchant that owns the account is suspected of using the account fraudulently. An account may be referred to collections because the merchant has accumulated a debit balance that the merchant is not paying. An account may be referred to collections because the merchant's business has become increasingly risky, thus causing the processing organization to consider the need to establish or increase a reserve of funds to offset the risk. It may also be the case that, prior to establishing the account, the underwriting organization believes a reserve of funds should be maintained relating to the account, in which case the underwriting organization may refer the account to collections for proper allocation of the reserve funds. Other reasons are possible.

A user, such as a collections officer, at the collection officer computer 112 may develop information relating to a merchant's account and transmit the information to the server computer 102 for storage in the database 110. For example, the collections officer may successfully obtain funds from a merchant to offset an outstanding balance or to create a reserve of funds to be maintained relating to the merchant's account. Even if unsuccessful in obtaining funds from a merchant, the collections officer may need to document attempts to obtain the funds for future reference. The collections officer may also need to generate letters, such as dunning letters to send to a merchant having an outstanding debit balance. The server computer 102 may also respond to commands from the collection officer computer 112 to generate one or more reports, which the server computer 102 transmits to the collection officer computer 112. Thereafter, the collection officer computer 112 may respond to commands from a user to output the report on, for example, a printer 114.

FIG. 1 also illustrates a financial analyst computer 116 connected to the network 104. Using the financial analyst computer, a financial analyst may access information relating to collections and reserve matters regarding merchants. For example, the financial analyst may receive information from a collections officer that the collections officer has successfully obtained funds from a merchant in collections, in which case the funds must be allocated appropriately. Additionally, the financial analyst may need to determine the most appropriate allocation of reserve funds for a new or existing client having additional funds maintained in reserve by the processing organization. Further still, a financial analyst may need to make a decision regarding liquidating reserve funds to cover a merchant's outstanding balance. Many other examples are possible.

The server computer 102, financial analyst computer 116, and/or the collection officer computer 112 may be configured more specifically to perform the methods of the present invention and employ the graphical user interface to be described hereinafter. It merits noting that in some embodiments of the present invention, the server computer 102, the collection officer computer 112, the financial analyst computer 116, and the database 110 exist together in a single computing device.

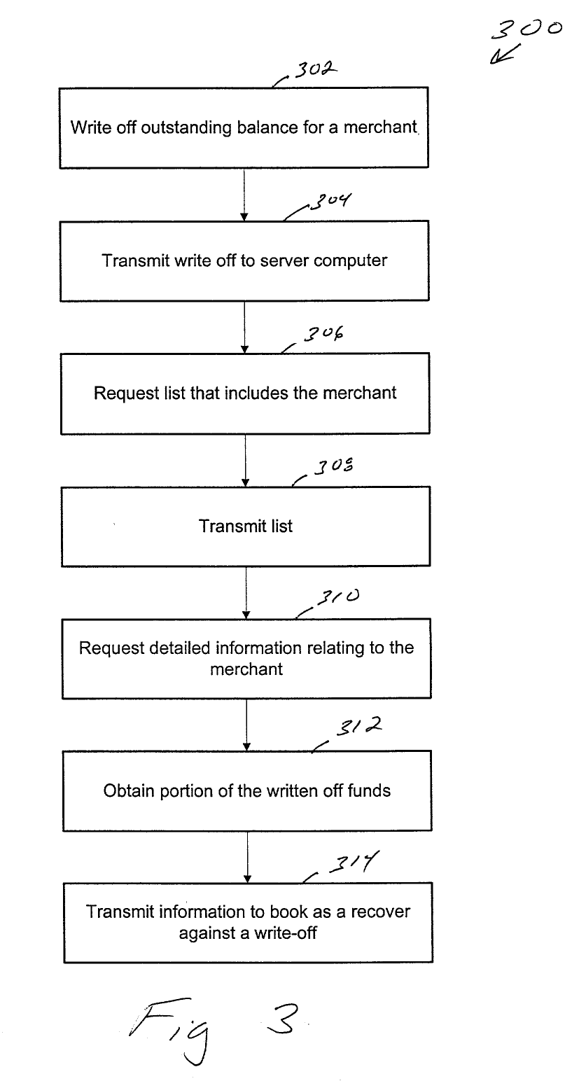

Referring to FIG. 2, a method 200 for facilitating the collection of outstanding funds from merchant accounts is illustrated. At operation 202, merchants are referred to collections. The merchants may be referred to collections for many reasons, as previously discussed. At operation 204, a collections officer requests a list of merchants in the collections system. The collections officer may request a complete list or a partial list using any number of criteria. The list is transmitted to the collections officer at operation 206.

From the list, the collections officer may select one merchant to review in greater detail at operation 208. The more detailed information is transmitted at operation 210. Using the detailed information relating to the merchant, the collections officer may take any of several actions to attempt to collect funds from the merchant. For example, the collections officer may attempt to generate an electronic funds transfer from an account owned by the merchant, as indicated by operation 212. The collections officer might also attempt to contact the merchant by phone or mail, as indicated by operation 214. The collections officer may also send a dunning letter to the merchant, as indicated by operation 216. Many other examples are possible.

If the collections officer is successful obtaining funds to cover all or a portion of the merchant's outstanding balance, the collections officer may document this in an electronic file associated with the merchant by transmitting the information to the server computer at operation 218. Even if the collections officer is unable to collect funds from the merchant, the collections officer may document his attempts at operation 218, as well. As indicated by operation 220, the collections officer may generate reports relating to collections activities.

At operation 222, a financial analyst may access a list of merchants in the collections system. The list may be a complete list or only a partial list of merchants matching certain criteria. For example, the financial analyst may only access merchants having a reserve balance. The list is transmitted at operation 224. At operation 226, the financial analyst may request more detailed information on a specific merchant, which detailed information is transmitted at operation 228. Based on the information, the financial analyst may take any of several actions. For example, if the merchant was referred to collections during the underwriting process and the merchant has provided finds to be held in reserve, the financial analyst may determine how the reserve funds should be allocated. This is shown at operation 230. At operation 232, the financial analyst may decide how funds collected by a collections officer should be allocated. At operation 234, the financial analyst may transmit the information to the server computer to be maintained in an electronic file relating to the merchant. At operation 236, the financial analyst may generate reports relating to collection activity.

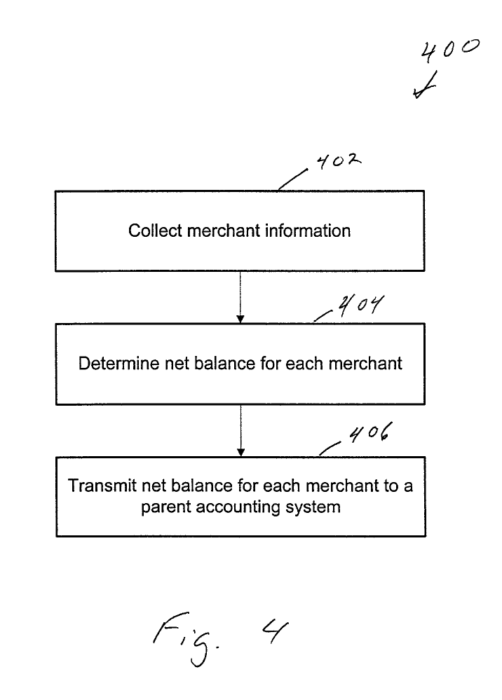

Referring to FIG. 3, another embodiment of the present invention will be discussed. FIG. 3 illustrates a method 300 of facilitating the collection of outstanding funds. At operation 302, a merchant's outstanding balance is written off for tax purposes and the information is transmitted to the server computer to be maintained in an electronic file associated with the merchant at operation 304. At operation 306, the merchant is included in a list of merchants requested by a collections officer and is transmitted to the merchant at operation 308. The collections officer requests and receives detailed information relating to the merchant at operation 310, which information includes an indication that at least a portion of the merchant's outstanding balance was written off. At operation 312, the collection officer successfully obtains a portion of the funds written off relating to the merchant. At operation 314, the collections officer transmits information to the server computer to be included in an electronic file associated with the merchant indicating that the collected funds represent a recovery against a write-off.

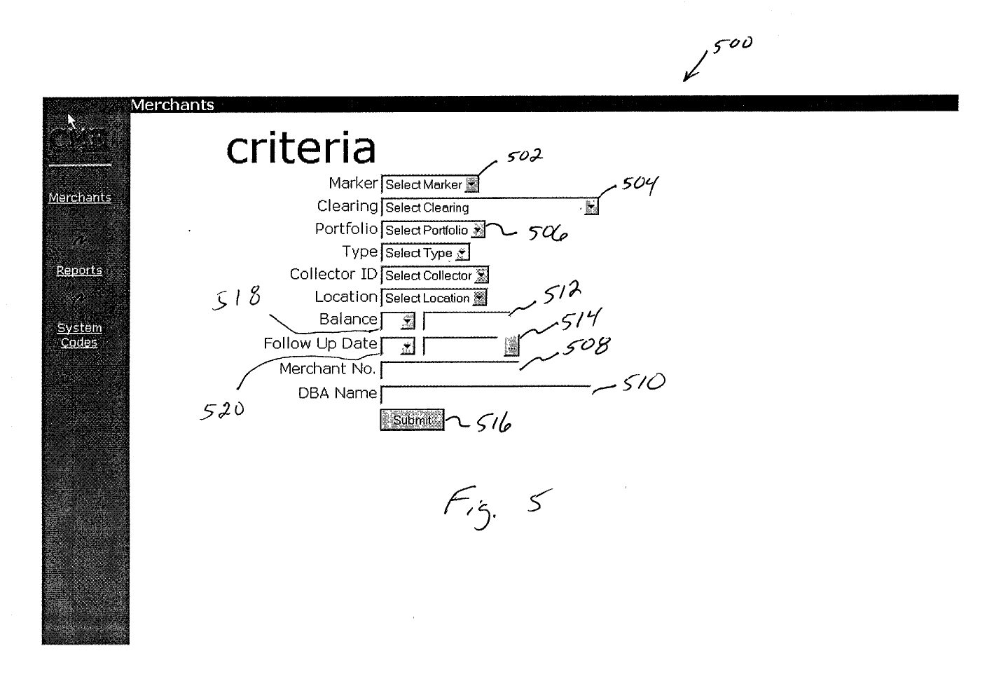

Referring to FIG. 4, another embodiment of the present invention will be described. FIG. 4 illustrates a method 400 for facilitating the collection of outstanding funds. At operation 402, information is collected relating to the merchants in the collections system. The information includes transaction information having debits and credits with respect to the balance of funds owed to the merchant or the funds owed by the merchant. The transaction information may also include reserve account information indicating the amount of funds maintained in reserve for a merchant to offset any balance owed by the merchant. Some merchants in the collections system may not have a reserve balance, while others may have a reserve balance being used to offset a debit balance. At operation 404, the net balance is determined for each merchant. The net balance is generally calculated by subtracting from any reserve balance the outstanding balance of funds owed by the merchant. At operation 406, the net balance for each merchant is passed to a parent accounting system. Thus, the method 400 represents a method for maintaining a sub-ledger having merchant transaction information relating to the collections system, the summary of which is supplied to a general ledger representing the general accounting system for the credit processing organization.

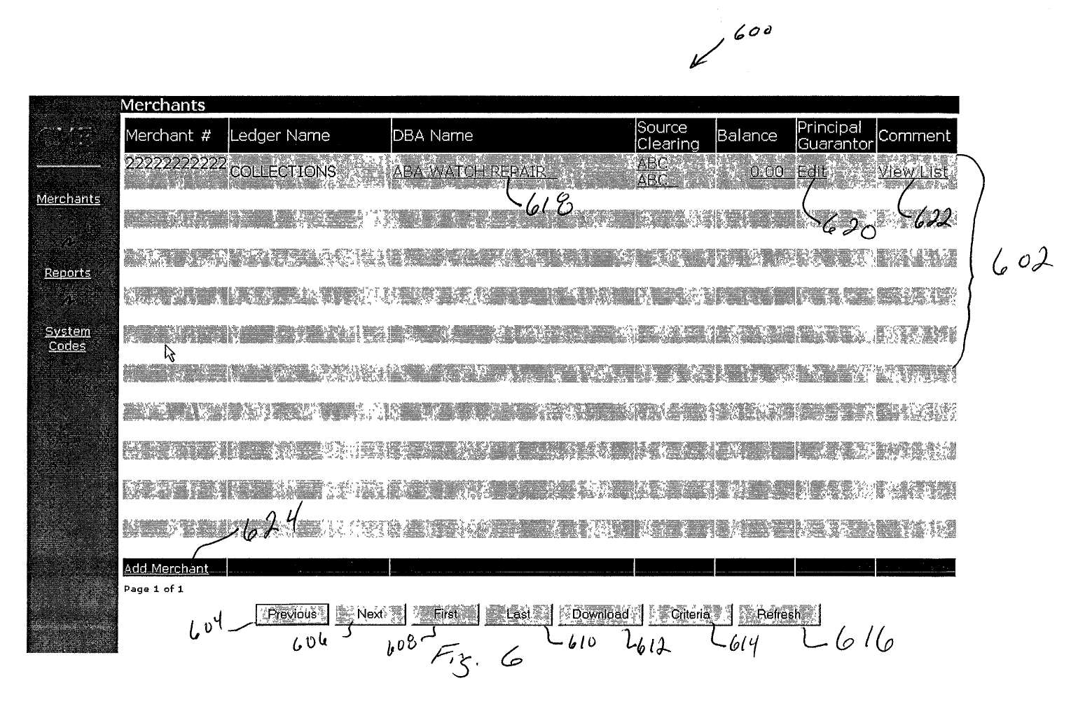

As stated previously, the present invention may include a web browser environment that allows collections officers and financial analysts to recall and evaluate merchant account and transaction information over a network. FIG. 5 illustrates a first screen display 500 that may be used by an analyst or collector in this process. Screen display 500 is a query screen that might be used, for example, by a collections officer to select specific merchants for review who have been referred to collections. Using respective fields 502, 504 and 506, a collections officer may select merchants by marker, clearing or portfolio. Merchants also may be selected by number or name using the merchant no. data field 508 or the DBA name field 510, respectively. Collections officers may also select merchants by balance using balance field 512 or follow up date using follow up date field 514. Many other selection criteria are possible, and combinations of criteria also may be used. Conveniently, Boolean operators may be used to further refine the criteria for selecting merchants. A balance Boolean field 518 and a follow up date Boolean field 520 may be used to select, for example, balances less than a specified amount or follow up dates after a specified date. Once appropriate criteria are entered, the collections officer may select the submit button 516 to transmit the criteria to a server computer.

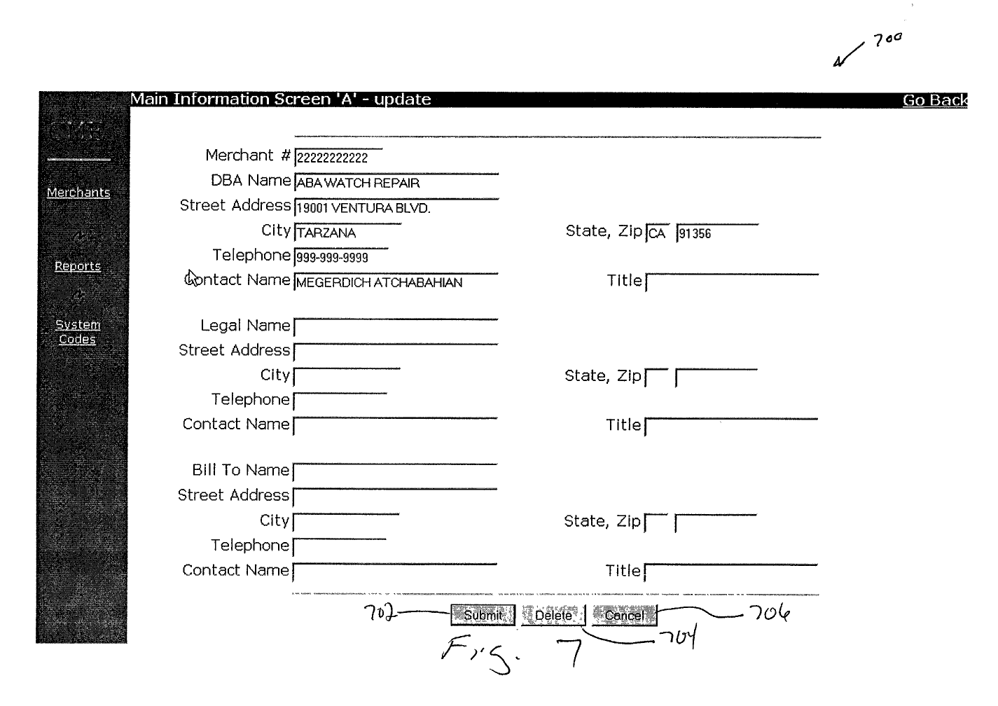

Referring to FIG. 6, a display screen 600 is shown that depicts a possible result of selecting the submit button 516 of FIG. 5. The display screen 600 includes a list 602 of merchants matching the criteria. The display screen also includes navigation buttons for navigating through a list having more merchants than can fit on a single display screen. For example, a previous button 604, a next button 606, a first button 608 and a last button 610 display the previous, next, first or last pages, respectively in the list. A download button 612 allows the displayed data within the queue to be exported to an external spreadsheet program. A criteria button 614 allows the collections officer to select merchants using different criteria. A refresh button 616 updates the display screen with current information from the server computer.

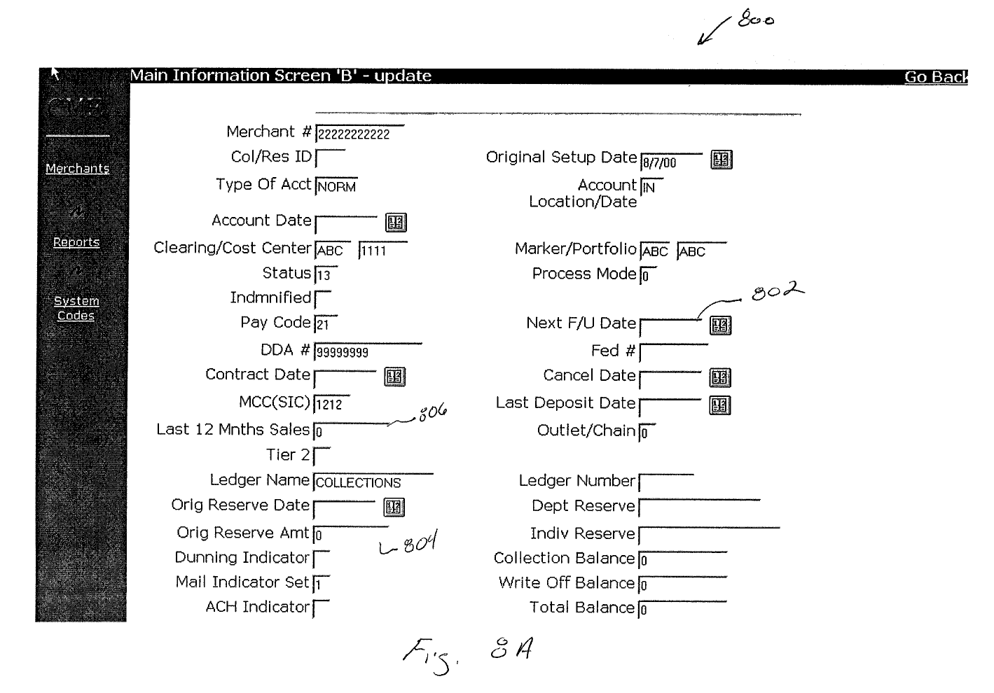

The display screen 600 also includes several items that function as hyperlinks to cause different display screens to be displayed. For example, the DBA name hyperlink 618 requests more detailed information regarding a selected merchant to be displayed. The more detailed information screen is shown in FIG. 7.

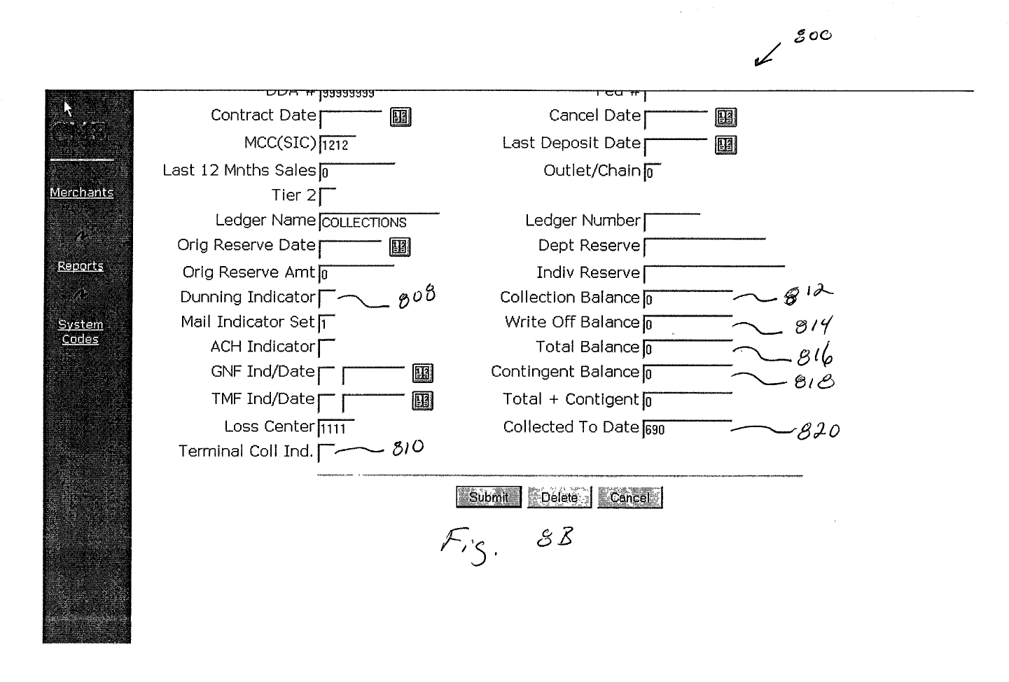

FIG. 7 illustrates an ‘A’ information screen 700 having mostly demographic information relating to the selected merchant. A collections officer or financial analyst may enter or change information using the appropriate data fields. A collections officer also may use the information to attempt to contact the merchant to obtain funds. A submit button 702 transmits the information to a server computer. A delete button 704 allows the information to be deleted, and a cancel button 706 aborts the operation. Selecting the submit button 702 also causes the ‘B’ information screen 800 to be displayed as shown in FIGS. 8A and B.

Referring to FIGS. 8A and B, the top and bottom portions, respectively, of the ‘B’ information screen 800. The B information screen 800 includes substantial information relating to the status of a merchant's account. The information is useful to both collections officers and financial analysts in managing collections issues relating to a merchant. While particular data fields may be selected for inclusion in different embodiments of the present invention depending on the particular needs and circumstances of the credit processing organization, key data fields specific to this example of the present invention include: a next F/U date field 802; an orig reserve amt field 804; a last 12 mnths sales field 806; a dunning indicator field 808; a terminal coll ind. field 810; a collection balance field 812; a write off balance field 814; a total balance field 816; a contingent balance field 818; and a collected to date field 820.

The next F/U date field 802 sets a flag to trigger the merchant to be reviewed again at a future date. The orig reserve amt field 804 indicates the amount of funds held in reserve when a reserve amount was first established for the merchant. The last 12 mnths sales field 806 indicates the sales volume for the merchant in the previous year. The dunning indicator field 808 indicates whether a dunning letter has been sent to the merchant. The terminal coll ind. field 810 indicates whether a merchant is still in possession of a point of sale terminal for which the merchant owes money. The collection balance field 812 indicates the amount of money owed by the merchant to the credit processing organization. The write off balance field 814 indicates whether any portion of the merchant's outstanding balance has been written off as uncollectible. The total balance field 816 is the total reserve (merchant funds held as collateral) or collections (receivable due from merchant) balance outstanding. If the balance represents collections, the balance may include write-offs. The contingent balance field 818 is a separate balance used to track collection balances already written-off. The collected to date field 820 indicates what, if any, funds have been collected from the merchant.

Thus, using the information provided via the data fields of the ‘B’ information screen 800, a collections officer may determine how much money a merchant owes, determine whether the processing organization is maintaining a reserve balance for the merchant, evaluate the merchant as a customer, and decide how best to proceed with obtaining funds from the merchant. If the merchant has an account in the ACH (automated clearing house) system, the collections officer may be able to note this fact based on the information in the ‘B’ information screen and proceed with attempting to acquire funds using the account. The collections officer also may enter information that he develops in the course of attempting to collect funds. As will be described below, the collections officer also may be able to use data from the ‘B’ information screen 800 in combination with data from other display screens to more effectively collect funds from merchants.

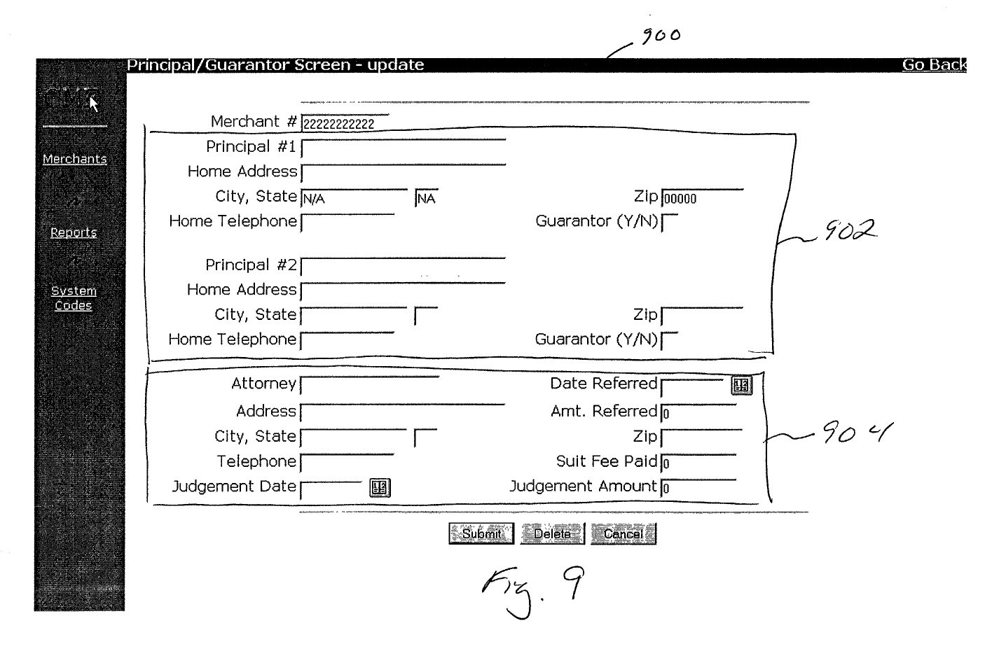

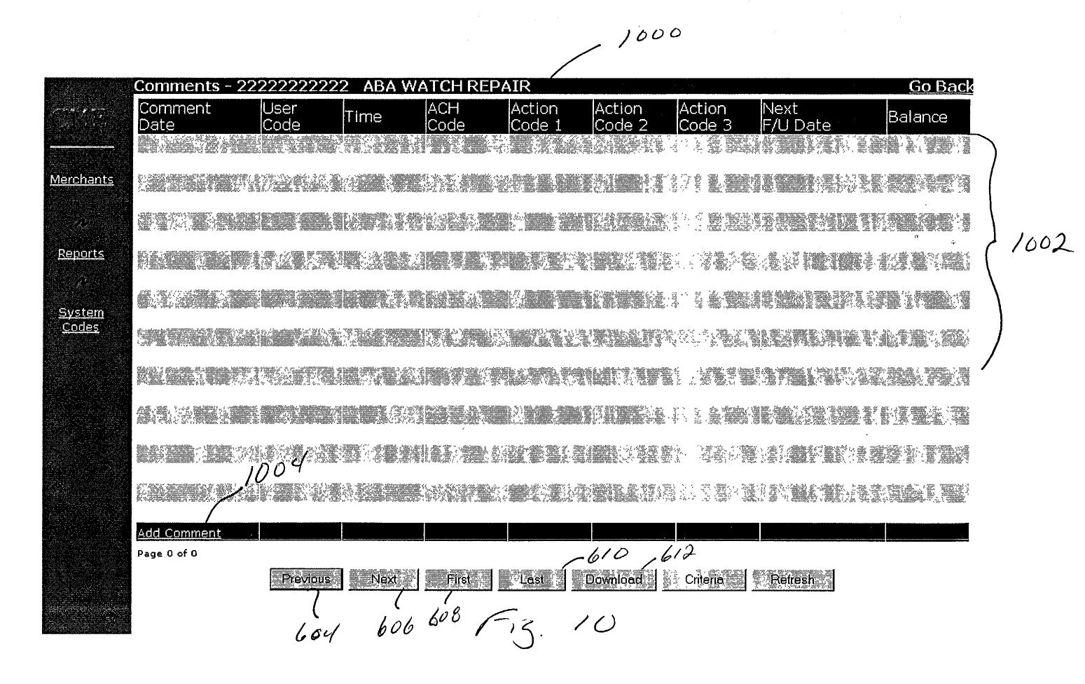

Referring back to FIG. 6, additional hyperlinks are provided for viewing or entering other information relating to a merchant. For example, the principal guarantor hyperlink 620 causes the principal/guarantor screen 900 of FIG. 9 to be displayed. The comment hyperlink 622 causes the comment display screen 1000 of FIG. 10 to be displayed. An add merchant hyperlink 624 may be used to add a merchant to the collections system.

Referring to FIG. 9, the principal/guarantor screen 900 includes data fields relating to principals of the merchant (principal information area 902). Other data fields indicate whether any portion of the merchant's outstanding balance has been referred to an attorney for collections and whether a judgment has been entered with respect to the balance (judgment information area 904).

Referring to FIG. 10, a comment screen 1000 provides a number of items to indicate various actions that have been taken with respect to a merchant. Comments are summarized in a comment summary area 1002. Using hyperlinks (not shown) a collections officer may select a comment to review in greater detail. Using navigation buttons explained previously (previous 604, next 606, first 608, last 610), the collections officer may page through lists of comments. The collections officer may add comments by selecting the add comment button 1004.

Thus, using the various display screens (‘A’ information screen 700, ‘B’ information screen 800, principal/guarantor screen 900 and comment screen 1000), a collections officer may develop view collections information relating to a merchant, determine how best to obtain funds from a merchant and enter information to document his efforts and results. Conveniently, a collections officer's work may be assisted further through the use of decision trees.

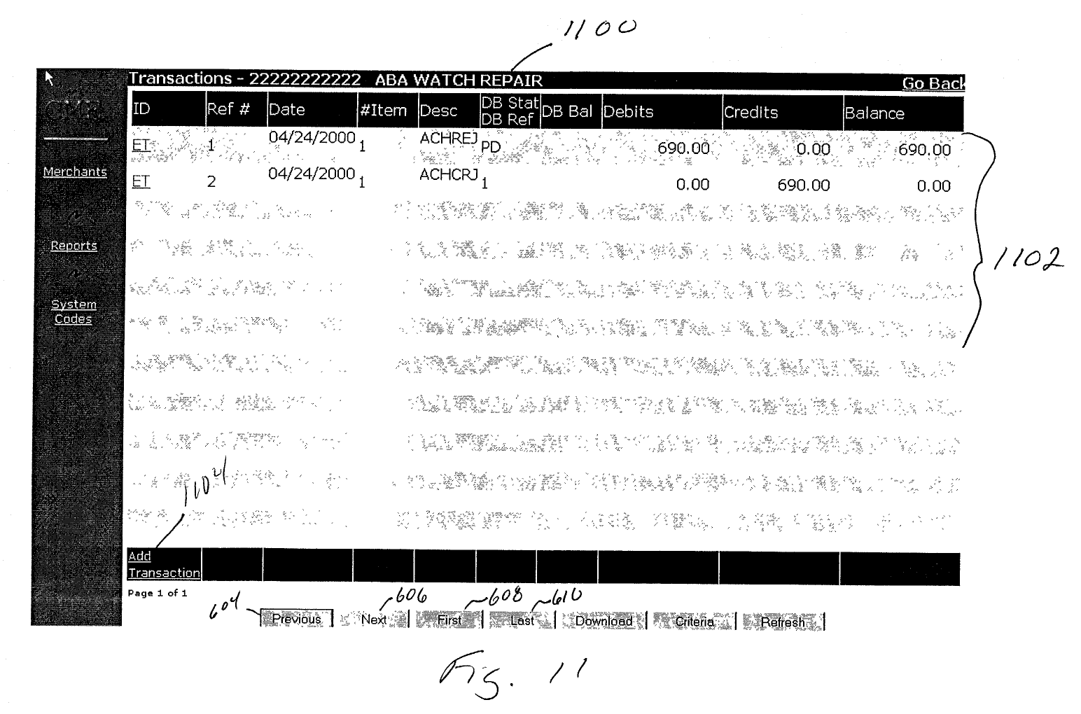

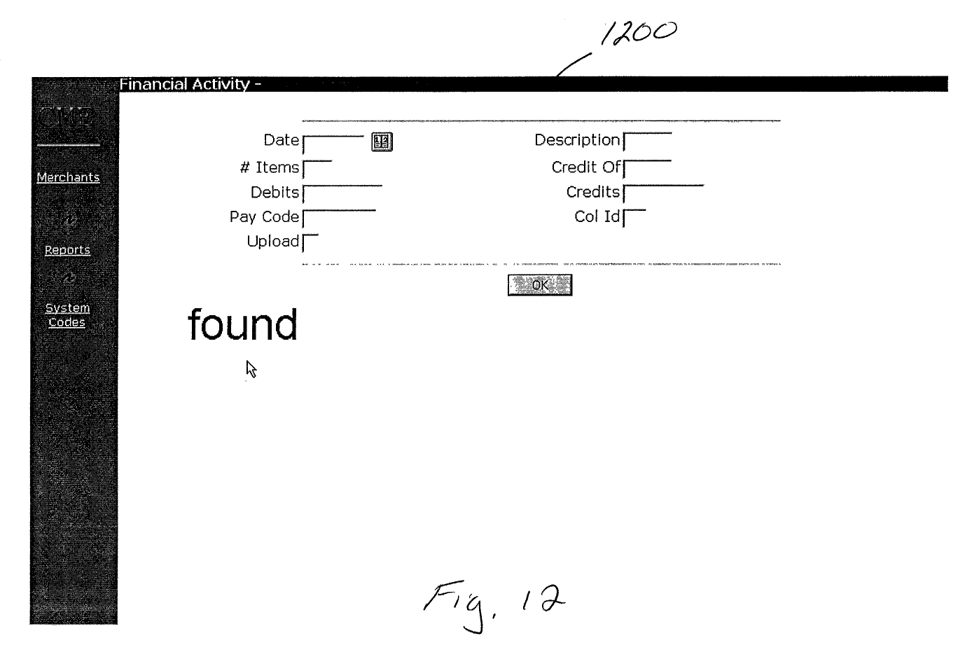

FIG. 11 illustrates a financial analyst's screen 1100 that may be used to enter transactions relating to a merchant. For example, when a collections officer successfully obtains funds from a merchant, a financial analyst determines how to allocate the funds. Transactions are listed in a transactions list 1102, and the previously mentioned navigation buttons may be used to page through multiple transaction screens. Additional transactions may be added using the add transaction button 1104. FIG. 12 illustrates an example transaction screen 1200 for a merchant that appears in response to selecting the add transaction button. A financial analyst also may use the financial analyst's screen 1100 and transaction screen 1200 to enter transactions relating to the allocation of reserve funds maintained for a merchant. The transactions entered using the financial analyst's screen 1100 may be summarized and reported into a higher level accounting system. Thus, the transactions act as a more detailed sub-ledger to a general ledger in the accounting system.

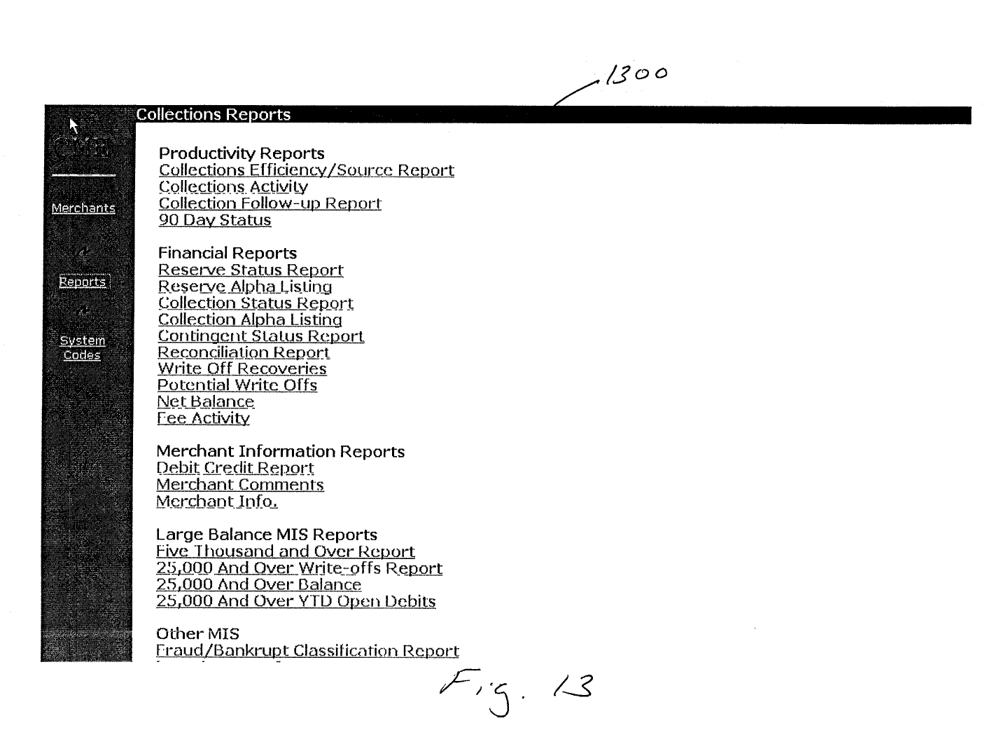

FIG. 13 illustrates a reports request screen 1300 for requesting reports relating to merchants in collections. Reports may be designed according to the particular needs and circumstances of the credit processing organization. Reports may illustrate the magnitude of collections-related issues and serve as a check on the progress of collections officers in obtaining funds from merchants with outstanding balances.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computers into a network and enable communication among the computers through the use of web-browser software. Accordingly, the above description should not be taken as limiting the scope of the invention, which is defined in the following claims.

What is claimed is:

1. A method of facilitating the collection of outstanding funds from merchants having an outstanding funds balance, comprising:
receiving at a server computer transaction information relating to a plurality of merchants;
receiving a request to generate a list of merchants exceeding certain payment risk criteria;
transmitting the list to a collections computer;
receiving a request at the server computer to view account information for one of the merchants on the list;
transmitting requested account information; and
receiving “follow up” information at the server computer relating to actions taken by a collections officer to reduce the payment risk.

2. The method of claim 1, wherein the payment risk criteria comprises only merchants having outstanding funds balances over a particular amount.

3. The method of claim 1, wherein the follow up information includes flagging the merchant for subsequent review at a future date.

4. The method of claim 3, wherein the payment risk criteria includes only merchants flagged for review after a particular date.

5. A method for facilitating the collection of outstanding funds from merchants having an outstanding funds balance, comprising:
receiving at a server computer transaction information relating to a plurality of merchants;
receiving a request to generate a list of merchants exceeding certain payment risk criteria;
transmitting the list to a collections computer;
receiving a request at the server computer to view account information for one of the merchants on the list;
transmitting requested account information; and
receiving “account treatment” information at the server computer relating to how an analyst has applied collected funds to an account.

6. The method of claim 5, further comprising summarizing the account treatment information and transmitting the summarized account treatment information to a general ledger.

7. A method of collecting outstanding funds from a merchant, comprising:
requesting from a server computer a list of merchants having outstanding balances;
selecting one of the merchants and requesting from the server computer a file of information relating to the selected merchant; and
using the merchant information to attempt to collect funds from a merchant account using an electronic funds transfer.

8. The method of claim 7, further comprising sending a dunning letter to the merchant.

9. The method of claim 7, further comprising using the information to contact a principal representing the merchant.

10. The method of claim 7, further comprising forwarding the information to an attorney for the commencement of judicial proceedings to attempt to collect funds from the merchant.

11. The method of claim 7, further comprising using a decision tree to manage information relating to the merchant.

12. A method of allocating funds collected from a merchant, comprising:
from a financial analyst computer, requesting from a server computer a list of merchants from whom funds have been collected;
selecting one of the merchants and requesting from the server computer a file of information relating to the selected merchant; and
entering information into the financial analyst computer to allocate the funds in a particular manner.

13. The method of claim 12, wherein the funds are allocated to a reserve account to be held to offset the possibility that the merchant may accumulate a balance of funds owed.

14. The method of claim 12, wherein at least a portion of the funds are allocated to cover at least a portion of an outstanding balance accumulated by the merchant.

15. A method of facilitating the allocation of reserve funds, comprising:
receiving at a server computer a request from a financial analyst to transmit a list of merchants having reserve funds;
transmitting the list to a financial analyst computer;
receiving at the server computer a request from the financial analyst to transmit merchant information relating to one of the merchants in the list of merchants, wherein the merchant information includes an amount of reserve funds for the requested merchant;
transmitting the requested merchant information to the financial analyst computer; and
receiving at the server computer an instruction to allocate the reserve funds in a certain manner.

16. The method of claim 15, wherein the instruction includes liquidating at least a portion of the reserve funds to cover at least a portion of an outstanding balance accumulated by the first merchant.

17. In a computer system configured to facilitate debt collection, the computer system including a server computer and a database associated with the server computer, wherein the database includes electronic records identifying merchants having balances of funds owed, wherein the electronic records include a balance owed field that indicates an amount owed and a write-off field that indicates any portion of the outstanding balance deemed uncollectible and written off for accounting purposes, and wherein at least one merchant has a write-off amount in the write-off field of an electronic record associated with the merchant, the method comprising:
including the identify of the merchant in a list of merchants having balances of funds owed;
periodically transmitting the list from the server computer to a collection officer computer; and
attempting to collect funds from the merchant.

18. The method of claim 17, further comprising:
receiving funds from the merchant;
entering an instruction into a data entry screen on the collection officer computer to account for the funds as a collection against a write-off;
transmitting the instruction to the server computer; and
storing the amount of funds received in the electronic record associated with the merchant.
